(19) United States
(12) Patent Application Publication
(10) Pub. No.: US 2003/0048877 A1
(43) Pub. Date: Mar. 13, 2003

(54) X-ray source and method of using the same

(76) Inventors: L. Stephen Price, Richland, WA (US); David J. Watson, Richland, WA (US); Dan Schoephlin, Richland, WA (US); Don Kenning, Kennewick, WA (US)

Correspondence Address: KENNETH E. HORTON, RADER, FISHMAN & GRAUER PLLC, RIVERPARK CORPORATE CENTER ONE, 10653 SOUTH RIVERFRONT PARKWAY, SUITE 150, SOUTH JORDAN, UT, 84095, US

(21) Appl. No.: 09/951,253

(22) Filed: Sep. 11, 2001

(51) Int. Cl. H01J 35/16

(52) U.S. Cl. 378/203; 378/44; 378/156

(57) ABSTRACT

Apparatus and methods for providing x-rays to electronic devices such as portable electronic devices for x-ray fluorescence analysis are described. The apparatus includes a portable XRF device containing an x-ray source and an x-ray detector that are proximate one another, e.g., within the same housing. The x-ray source is shielded so that x-rays that could potentially interfere with the operation of the x-ray detector are reduced or eliminated.

### FIELD OF THE INVENTION

The invention generally relates to apparatus and methods for providing x-rays. More particularly, the invention relates to apparatus and methods for providing x-rays used in electronic devices. Even more particularly, the invention relates to apparatus and methods for providing x-rays for an x-ray device, including portable x-ray devices, and methods for using the same.

### BACKGROUND OF THE INVENTION

There has been significant interest in apparatus and methods for identifying and verifying various articles or products such as explosives, ammunition, paint, petroleum products, and documents. Known methods used to identify and verify generally involve adding and detecting materials like code-bearing microparticles, bulk chemical substances, and radioactive substances. Other methods used for identifying and verifying articles include those described in U.S. Pat. Nos. 6,030,657, 6,024,200, 6,007,744, 6,005,915, 5,849,590, 5,760,394, 5,677,187, 5,474,937, 5,301,044, 5,208,630, 5,057,268, 4,862,143, 4,390,452, 4,363,965, and 4,045,676, as well as European Patent Application Nos. 0911626 and 0911627, the disclosures of which are incorporated herein by reference.

It is also known to apply materials to articles in order to track, for example, point of origin, authenticity, and their distribution. In one method, inks that are transparent in visible light are sometimes applied to materials and the presence (or absence) of the ink is revealed by ultraviolet or infrared fluorescence. Other methods include implanting microscopic additives that can be detected optically. However, detecting these materials is primarily based on optical or photometric measurements.

Numerous devices are known for identifying and verifying articles containing such materials (called taggants) by x-ray fluorescence (XRF). See, for example, U.S. Pat. Nos. 5,461,654, 6,130,931, 6,041,095, 6,075,839, 6,097,785, and 6,111,929, the disclosures of which are incorporated herein by reference. Unfortunately, many of the known apparatus for are unsatisfactory for several reasons. First, they are often difficult and time-consuming to use. In many instances, a sample of the article must be sent to an off-site laboratory for analysis. In other instances, the apparatus are often expensive, large, and difficult to operate. For example, the known apparatus and methods for identification and verification are also unsatisfactory because the devices employed are usually not portable.

Even when portable, their ability to adequately operate and analyze a taggant in a sample is also quite limited. To obtain the desired portability, the size of the XRF device must be decreased. In one decreased size configuration, the x-ray source and the x-ray detector are located proximate one another. In such a configuration, however, x-rays from the source and its shielding can interfere with the operation of the detector.

### SUMMARY OF THE INVENTION

The invention provides apparatus and methods for providing x-rays used in electronic devices, such as portable electronic devices for x-ray fluorescence analysis. The apparatus includes a portable XRF device containing an x-ray source and an x-ray detector that are proximate one another, e.g., within the same housing. The x-ray source is shielded so that x-rays that could potentially interfere with the operation of the x-ray detector are reduced or eliminated.

### BRIEF DESCRIPTION OF THE DRAWINGS

FIGS. 1, 2a, 2b, 3, 4a, 4b, and 5-9 are views of apparatus and methods for providing x-rays according to the invention, in which:

FIG. 1 depicts the operation of XRF generally;

FIGS. 2a and 2b illustrate the operation of XRF at the molecular level;

FIG. 3 shows an exemplary x-ray spectrum, e.g., for paper;

FIGS. 4a and 4b depict two aspects of the of the XRF apparatus of the invention;

FIG. 5 illustrates exemplary energy levels of x-rays in an x-ray spectrum;

FIG. 6 shows another aspect of the XRF apparatus of the invention;

FIG. 7 illustrates yet another aspect of the XRF apparatus of the invention;

FIG. 8 illustrates still another aspect of the XRF apparatus of the invention; and

FIG. 9 illustrates a spectra of oil produced using the XRF apparatus of the invention.

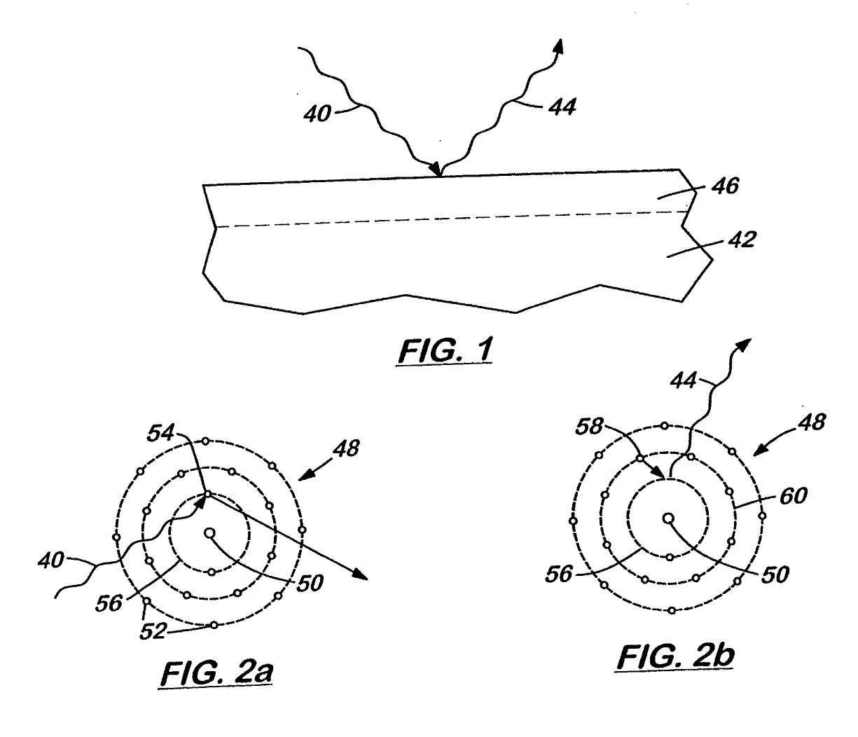

FIGS. 1, 2a, 2b, 3, 4a, 4b, and 5-9 presented in conjunction with this description are views of only particular-rather than complete-portions of apparatus and methods for providing x-rays according to the invention.

DETAILED DESCRIPTION OF THE INVENTION

The following description provides specific details in order to provide a thorough understanding of the invention. The skilled artisan will understand, however, that the invention can be practiced without employing these specific details. Indeed, the invention can be practiced by modifying the illustrated apparatus and method and can be used in conjunction with apparatus and techniques conventionally used in the industry. For example, the invention is described with respect to apparatus and methods for providing x-rays for XRF detecting apparatus. The invention described below, however, could be easily modified for apparatus and methods for providing x-rays in devices other than XRF apparatus, such as portable devices, benchtop systems, and other x-ray devices. Indeed, the apparatus and methods of the invention could be used in any known electronic device, whether portable or not, needing x-rays.

In one aspect, the invention uses x-ray fluorescence analysis to detect at least one taggant intrinsically or extrinsically present in the material of a product or article. With x-ray fluorescence (XRF) analysis, x-rays produced from electron shifts in the inner shell(s) of atoms of the taggants and, therefore, are not affected by the form (chemical bonding) of the article being analyzed. The x-rays emitted from each element bear a specific and unique spectral signature, allowing one to determine whether that specific taggant is present in the product or article.

FIGS. 1, 2a, and 2b represent how it is believed XRF generally operates. In FIG. 1, primary gamma rays or x-rays 40 are irradiated on a sample of a target material 46 of article 42. Secondary x-rays 44 are emitted from that sample of target material 46.

In FIGS. 2a and 2b, atom 48 of a taggant located within target material 46 has nucleus 50 surrounded by electrons 52 at discrete distances from nucleus 50 (called electron shells). Each electron shell has a binding energy level equal to the amount of energy required to remove that electron from its corresponding shell. The innermost shell is the K shell, and has the highest binding energy level associated with it. Electron 54 is located within K shell 56.

Primary x-ray or gamma ray photon 40 impacting atom 48 has a given energy. If that energy is greater than the binding energy level of K shell 56, the energy of x-ray photon 40 is absorbed by atom 48, and one of the electrons in K shell 56 (i.e., electron 54) is ejected. With a vacancy now in K shell 56 left by electron 54, atom 48 is energetic and unstable. To become more stable, that vacancy in K shell 56 can be—and usually is—filled by an electron located in a shell with a lower binding energy level, such as L-shell electron 58 in L shell 60. As L-shell electron 58 fills the vacancy in K shell 56, atom 48 emits a secondary x-ray photon 44. The energy levels (or corresponding wavelengths) of such secondary x-ray photons are uniquely characteristic to each taggant, allowing the presence or absence of any specific taggant to be determined.

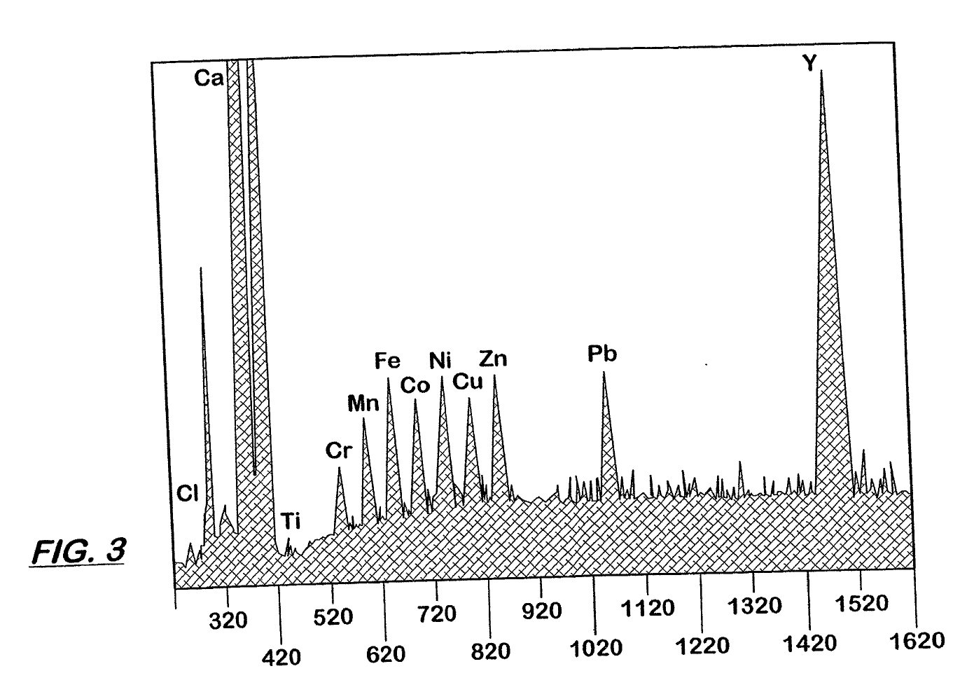

As shown in FIG. 3, the x-rays which are detected have various energies, e.g., there is a broad band of scattered x-rays with energies less than and greater than those of the exciting atom. FIG. 3 illustrates this spectrum for paper as the target material. Within this broad band, there are peaks due to the excitation of the taggant(s) in the sample. The ratio of the intensity of the radiation in any peak to the intensity of the background at the same energy (known as the peak-to-background ratio) is a measure of the concentration of the element which has characteristic X-rays at the energy of that peak, e.g., the taggant.

In one aspect of the detection method of the invention, at least one target material believing to contain known concentrations of the taggant(s) of interest is selected. The XRF analysis is performed on that target material (or a sample thereof) using a detection device or apparatus containing an x-ray radiation source (“source”), x-ray radiation detector (“detector”), support means, analyzer means, and calibration means. See, for example, the disclosures of U.S. Pat. Nos. 6,111,929, 6,256,373, 6,178,227, and 6,275,568, the disclosures of which are incorporated herein by reference.

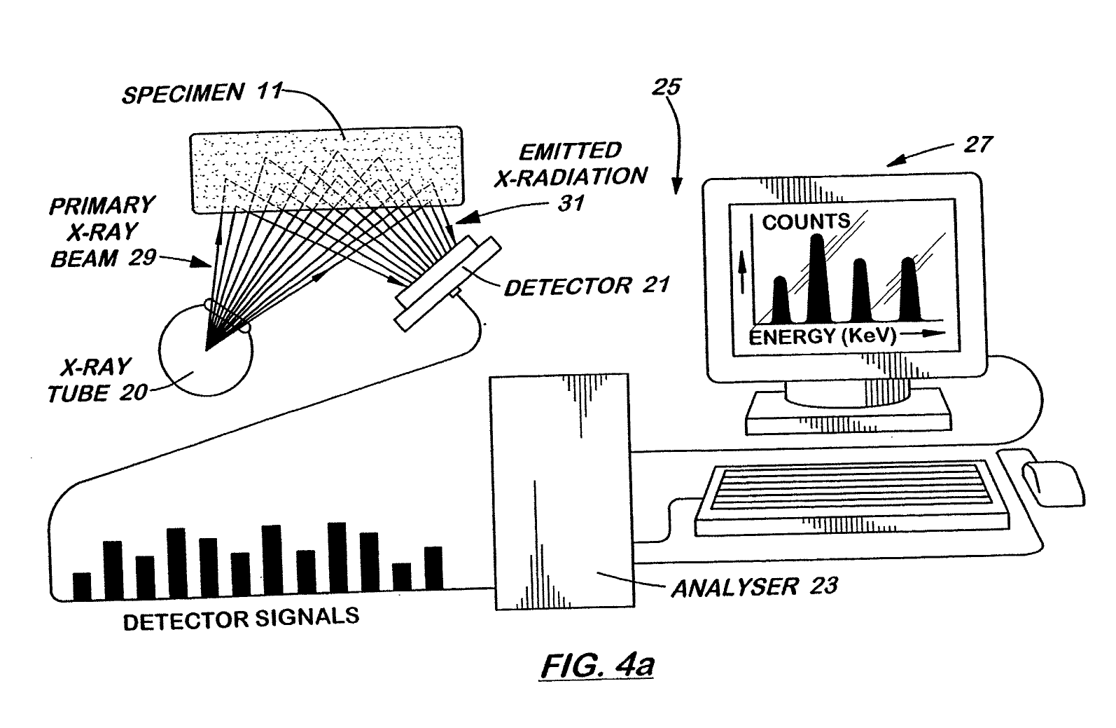

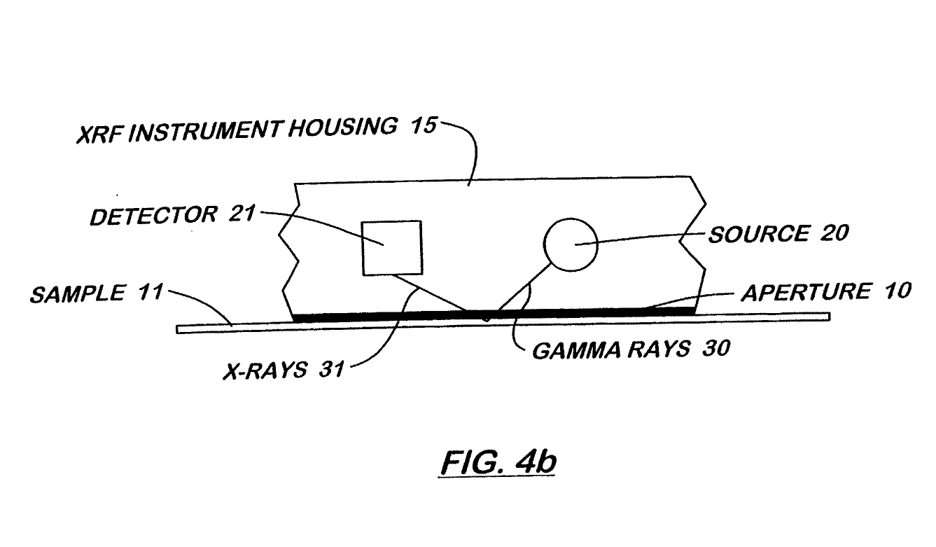

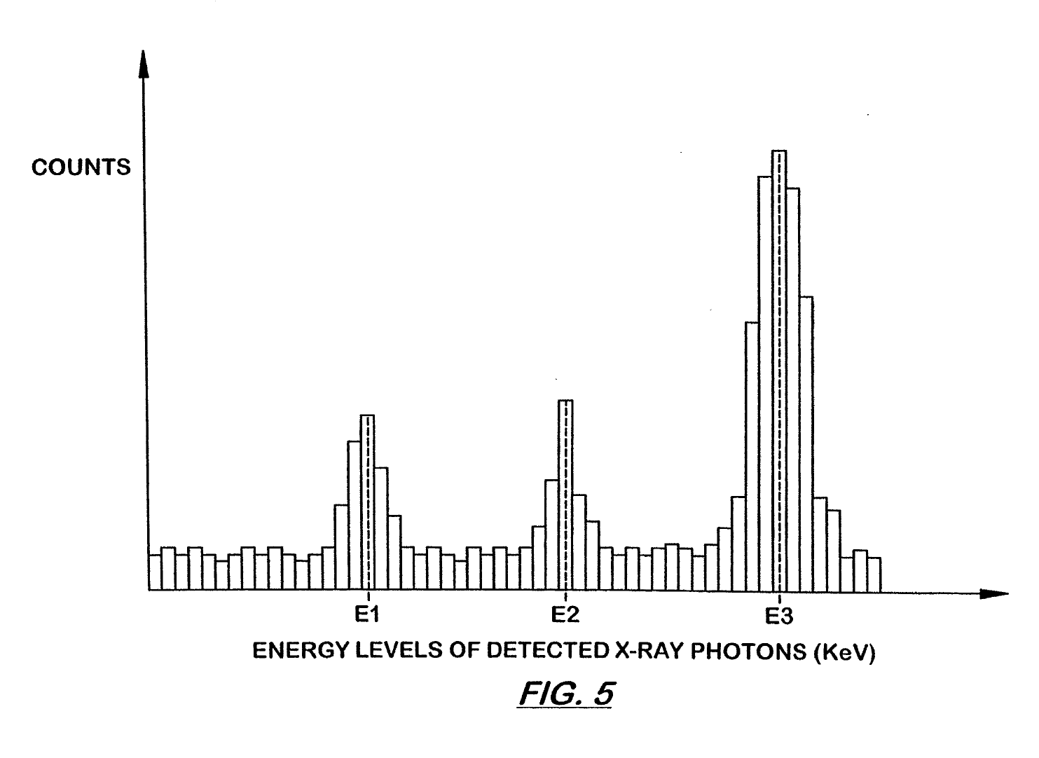

One aspect of the device of the invention is illustrated in FIG. 4a. In this Figure, the detection apparatus 25 has an ordinary x-ray fluorescence spectrometer capable of detecting elements present in a coating, package or material. X-rays 29 from a source (e.g., either x-ray tube or radioactive isotope) 20 impinge on a sample 11 which absorbs the radiation and emits x-rays 31 to an x-ray detector 21 and analyzer 23 capable of energy or wavelength discrimination. This is accomplished by using a commercially available x-ray spectrometer such as an Edax DX-95 or a MAP-4 portable analyzer, commercially available from Edax Inc., Mahwah, N.J. Part of analyzer 23 includes a computerized system 27.

Another aspect of the apparatus of the invention is illustrated in FIG. 4b. In this Figure, the detection apparatus 25 has an instrument housing 15 that contains the various components. Gamma rays or x-rays 30 from a source (e.g., either x-ray tube or radioactive isotope) 20 are optionally focused by aperture 10 to impinge on a sample 11. Sample 11 contains the at least one taggant which absorbs the radiation and emits x-rays 31 to an x-ray detector 21. Optionally, analyzing means can be incorporated within housing 15.

The invention, however, is not limited to the detection apparatus depicted in FIGS. 4a and 4b. Any suitable source, or plurality of sources, known in the art can be used as the source in the detection device of the present. See, for example, U.S. Pat. Nos. 4,862,143, 4,045,676, 6,005,915, 6,229,876, and 6,178,226, the disclosures of which are incorporated herein by reference. During the XRF detection process, the source bombards the taggant with a high-energy beam. The beam may be an electron beam or electromagnetic radiation such as X-rays or gamma rays. The source, therefore, may be any material emitting such high-energy beams. Typically, these have been x-ray emitting devices such as x-ray tubes or radioactive sources. The x-ray source is powered by any suitable power supply, as described below.

To target, the beam can be focused and directed properly by any suitable means such as an orifice or an aperture. The configuration (size, length, diameter . . . ) of the beam should be controlled, as known in the art, to obtain the desired XRF detection. The power (or energy level) of the source should also be controlled, as known in the art, to obtain the desired XRF detection.

As described more fully below, the source(s) can be shielded to emit radiation in a space limited by the shape of the shield. Thus, the presence, configuration, and the material used for shielding the source should be controlled for consistent XRF detection. Any suitable material and configuration for that shield known in the art can be employed in the invention. Preferably, any high-density materials used as the material for the shield, e.g., tungsten or brass.

Any suitable detector, or plurality of detectors, known in the art can be used as the detector in the detection device of the invention. See, for example, U.S. Pat. Nos. 4,862,143, 4,045,676, and 6,005,915, the disclosures of which are incorporated herein by reference. Any type of material capable of detecting the photons omitted by the taggant may be used. Silicon and CZT (cadmium-zinc-telluride) detectors have been conventionally used, but others such as proportional counters, germanium detectors, or mercuric iodide crystals can be used.

Several aspects of the detector should be controlled to obtain the desired XRF detection. First, the geometry between the detector and the target material should be controlled. The XRF detection also depend on the presence, configuration, and material—such as tungsten and beryllium—used as a window to allow x-rays photons to strike the detector. The age of the detector, voltage, humidity, variations in exposure, and temperature can also impact the XRF detection and, therefore, these conditions should be controlled.

The analyzer means sorts the radiation detected by the detector into one or more energy bands and measures its intensity. Thus, any analyzer means performing this function could be used in the invention. The analyzer means can be a multi-channel analyzer for measurements of the detected radiation in the characteristic band and any other bands necessary to compute the value of the characteristic radiation as distinct from the scattered or background radiation. See, for example, U.S. Pat. Nos. 4,862,143, 4,045,676, and 6,005,915, the disclosures of which are incorporated herein by reference.

The XRF also depends on the resolution of the x-rays. Background and other noise must be filtered from the x-rays for proper measurement, e.g., the signals must be separated into the proper number of channels and excess noise removed. The resolution can be improved by cooling the detector using a thermoelectric cooler—such as a nitrogen or a peltier cooler—and/or by filtering. Another way to improve this resolution is to use pre-amplifiers.

The support means supports the source and detector in predetermined positions relatively to a sample of the target material to be irradiated. Thus, any support means performing this function could be used in the invention. In one example, the support means comprises two housings, where the source and detector are mounted in a first housing which is connected by a flexible cable to a second housing in which the analyzer means is positioned as illustrated in FIG. 4a. If desired, the first housing may then be adapted to be hand-held. In another example, the source and detector as well as the other components of the detection device are mounted in a single housing as illustrated in FIG. 4b.

The calibration means are used to calibrate the detection apparatus, thus insuring accuracy of the XRF analysis. In this calibration, the various parameters that could be modified and effect the measurement are isolated and calibrated. For example, the geometrical conditions or arrangements can be isolated and calibrated. In another example, the material matrix are isolated and calibrated. Preferably, internal (in situ) calibration during detection is employed as the calibration means in the invention. Components, such as tungsten shielding, are already present to internally calibrate during the XRF analysis. Other methods, such as fluorescence peak or Compton backscattering, could be used for internal calibration in the invention.

Analyzer means, which includes a computerized system 27, is coupled to, receives, and processes the output signals produced by detector 21. The energy range of interest, which includes the energy levels of the secondary x-ray photons 44 emitted by the taggant(s), is divided into several energy subranges. Computerized system 27 maintains counts of the number of X-ray photons detected within each subrange using specific software programs, such as those to analyze the detection and x-ray interaction and to analyze backscatter data. After the desired exposure time, computerized system 27 with display menus stops receiving and processing output signals and produces a graph of the counts associated with each subrange.

FIG. 5 is a representative graph of the counts associated with each subrange. This graph is essentially a histogram representing the frequency distribution of the energy levels E1, E2, and E3 of the detected x-ray photons. Peaks in the frequency distribution (i.e., relatively high numbers of counts) occur at energy levels of scattered primary x-ray photons as well as the secondary x-ray photons from the taggant(s). A primary x-ray photon incident upon a target material may be absorbed or scattered. The desired secondary x-ray photons are emitted only when the primary x-ray photons are absorbed. The scattered primary x-ray photons reaching the detector of the system create an unwanted background intensity level. Accordingly, the sensitivity of XRF analysis is dependent on the background intensity level, and the sensitivity of XRF detection may be improved by reducing the amount of scattered primary x-ray photons reaching the detector. The peak occurring at energy levels of scattered primary x-ray photons is basically ignored, while the other peaks—those occurring at E1, E2, and E3—are used to identify the at least one taggant present in the target material.

Besides the parameters described above, at least two other parameters must be controlled during the process of XRF detection. First, the media (such as air) through which the gamma rays (and x-rays) must travel also impacts the XRF. Therefore, the different types of media must be considered when performing the XRF analysis. Second, the methods used to interpret and analyze the x-rays depend, in large part, on the algorithms and software used. Thus, methods must be adopted to employ software and algorithms that will consistently perform the XRF detection.

These two parameters, plus those described above, must be carefully accounted for and controlled to obtain accurate measurements. In one aspect of the intention, these parameters could be varied and controlled to another provide a distinct code. For example, using a specific source and a specific detector with a specific measuring geometry and a specific algorithm could provide one distinct code. Changing the source, detector, geometry, or algorithm could provide a whole new set of distinct codes.

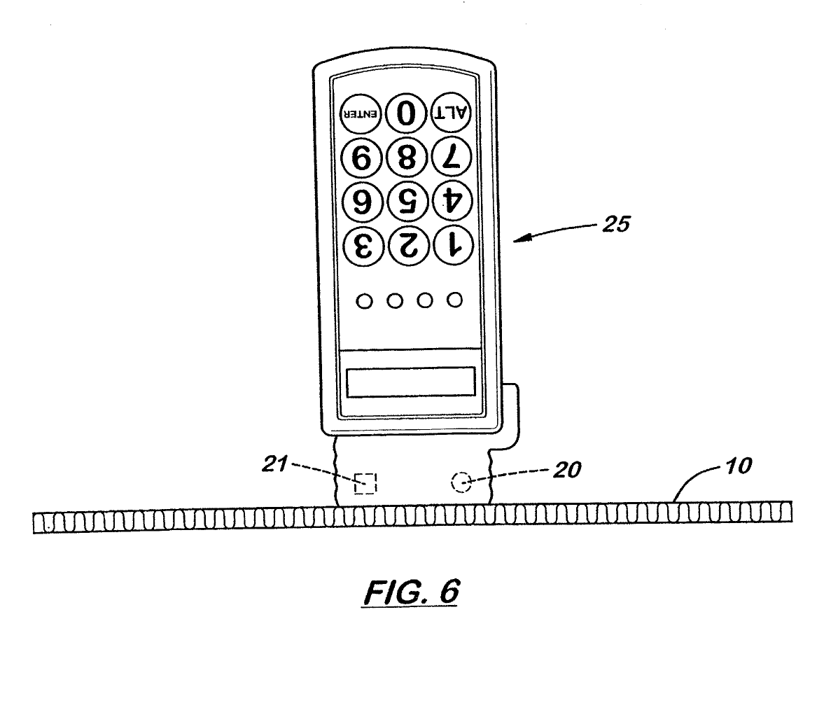

FIG. 6 illustrates one preferred apparatus and method according to the invention. In this Figure, detection apparatus 25 is capable of detecting at least one taggant present in target material 10. Detection apparatus 25 is a portable device that is small enough to be hand-held. Detection apparatus 25 contains all the components discussed above (i.e., source, detector, analyzer means, and calibration means) in a single housing, thus allowing the portability and smaller size.

In one aspect of the invention, the apparatus of the invention is configured with the source 20 and the detector 21 in close proximity. As noted above, the source(s) can be shielded with any suitable means known in the art. Thus, the shielding means must be carefully chosen and configured to minimize the amount of x-rays impacting the detector. Such x-rays would interfere with the function of the detector by distorting the spectrum detected. Such distortion would lead to erroneous analyzation of the sample.

Any shielding means known in the art that accomplishes the above functions can be employed in the invention. Part of the suitable shielding means includes primary shielding means (or primary shielding). The primary shielding comprises any suitable material able to decrease the radiation, both x-rays and/or gamma rays, with the desired energy level in any undesired directions as it is produced by the x-ray source during its operation. As well, the material must be dense (and thick) enough to reduce the radiation, strong enough to survive catastrophic damage, and yet can be easily machined. Any material meeting these requirements can be employed in the invention. High-density materials, like tungsten and brass, satisfy these requirements and so can be used in the invention as the material for the primary shielding. As well, any other high-density material can be employed as the material for the primary shielding. Preferably, tungsten is used as the material for the primary shielding.

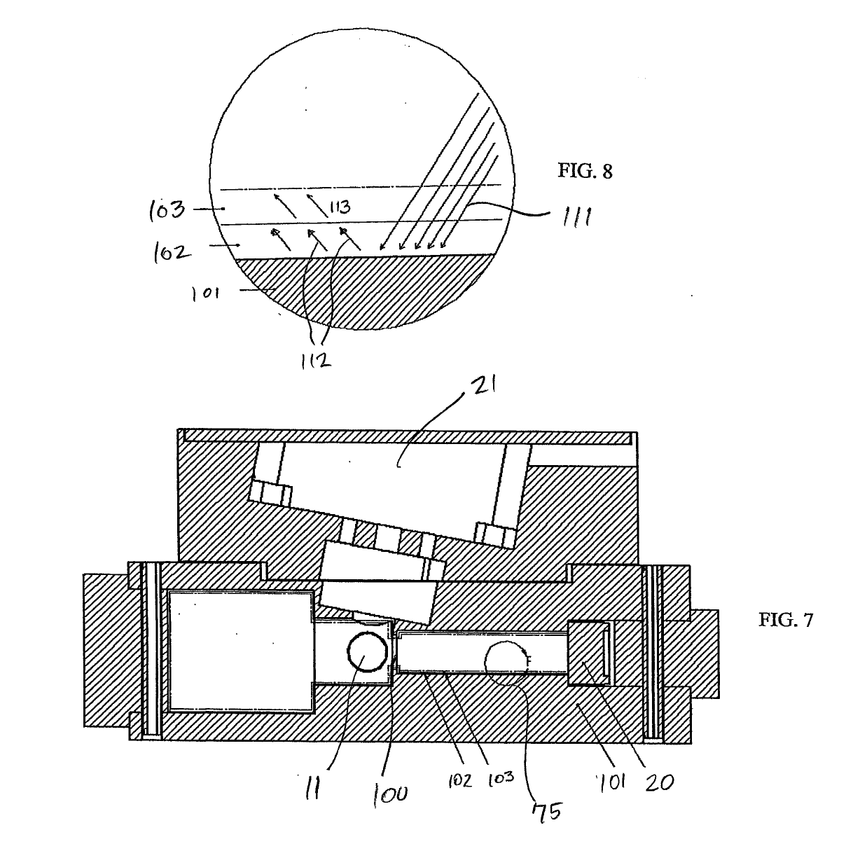

The primary shielding is configured to allow radiation in the desired direction (i.e., toward the sample to be analyzed) while reducing radiation in the undesired directions (i.e., toward the detector). In this aspect of the invention, the configuration of the primary shielding around source 20 is relatively simple to determine to minimize the radiation in the undesired directions: the shielding is placed (at a minimum) between the source 20 and the detector 21. Preferably, in the aspect of the invention illustrated in FIG. 7, the primary shielding 101 is configured to substantially enclose the source, with an opening (or aperture) 100 proximate the direction of sample 11.

The thickness of the primary shielding 101 should be sufficient to decrease the radiation to the desired level. Thus, the thickness will depends on several factors, such as the material used in the primary shielding, the space available for the primary shielding, and energy of x-ray or gamma ray source. For example, when tungsten is used as the primary shielding, the thickness can range from about a few millimeters to several hundred millimeters. For other materials, the thickness can range from about a few millimeters to several hundred centimeters depending on the density of the material and the x-ray or gamma ray source energy.

During its operation, the primary shielding is bombarded with radiation (primary x-rays 111) from the x-ray source as illustrated in FIG. 8 (which is an expanded view of section 75 in FIG. 7). Like other materials, when bombarded with x-rays, the material of the primary shielding (i.e., tungsten) will also fluoresce and emit x-rays 112. The radiation (i.e., x-rays) emitted from the primary shielding (the “secondary radiation” or “secondary x-rays”) are typically of an energy level lower than the primary x-rays striking the primary shielding. For example, in the case of a tungsten shielding and a Cadmium 109 gamma source, the primary x-rays striking the tungsten shielding have an energy of about 22.1 KeV and the secondary x-rays emitted from the tungsten typically have an energy of about 1.77 Kev and 8.39 KeV. These lower-energy secondary x-rays emitted from the primary shielding can interfere with the operation of the detector, as described above.

To overcome this disadvantage, the shielding means for the source 20 also includes secondary shielding means for shielding the secondary radiation emitted from the primary shielding means. The secondary shielding means (or secondary shielding) comprises a suitable material that is able to decrease, if not eliminate, the lower energy secondary radiation. The material for the secondary shielding must be dense (and thick) enough to reduce or eliminate the secondary radiation, strong enough to survive catastrophic damage, and yet can be easily machined. In addition, the secondary material must emit x-rays in a range low enough to not interfere with the spectral analysis. Any material meeting these requirements can be employed in the invention for the secondary shielding. In one aspect of the invention, silver and palladium satisfy these requirements and so can be used in the invention. Preferably, when tungsten is used in the primary shielding, silver is used as the material for the secondary shielding.

The thickness of the secondary shielding 102 should be sufficient to decrease the secondary radiation 112 to the desired level. Thus, the thickness of secondary shielding 102 will depend on several factors, such as the material used in the secondary shielding, the space available for the secondary shielding, and primary source energy. For example, when tungsten is used as the primary shielding and silver is used as the secondary shielding, the thickness of the silver shielding will be at least thick enough to stop the approximate 8.39 KeV photons emitted by the Tungsten primary shield. For other materials, the thickness will be determined by the mass absorption coefficient.

Like the primary shielding 101, the secondary shielding 102 is also bombarded with radiation. But the secondary shielding is bombarded with the secondary radiation 102 as illustrated in FIG. 8. Like other materials bombarded with x-rays, the material of the secondary shielding (i.e., silver) will also fluoresce and emit x-rays. The radiation (i.e., x-rays) emitted from the secondary shielding (the “tertiary radiation” or “tertiary x-rays”) 113 are typically of an energy level lower than the secondary radiation. For example, in the case of a tungsten primary shielding and silver secondary shielding, the secondary x-rays striking the silver shielding have an energy of about 8.39 KeV and 1.77 KeV and the tertiary x-rays emitted from the silver typically have an energy of about 2.98 KeV. These tertiary x-rays emitted from the secondary shielding can also interfere with the operation of the detector, as described above.

To overcome this disadvantage, the shielding means of the invention optionally include tertiary shielding means for shielding the tertiary radiation emitted from the secondary shielding. The tertiary shielding means (or tertiary shielding) 103 (illustrated with dotted lines in FIG. 8 to illustrate that it is optional) comprises a suitable material that is able to decrease, if not eliminate, the tertiary radiation. The material for the tertiary shielding must be thick enough to reduce the radiation, strong enough to survive catastrophic damage, and yet can be easily machined. Any material meeting these requirements can be employed in the invention for the tertiary shielding 103. As mentioned above, aluminum and magnesium satisfy these requirements and so can be used in the invention. Preferably, when tungsten is used in the primary shielding, and silver is used in the secondary shielding, aluminum can be used as the material for the tertiary shielding.

The thickness of the tertiary shielding 103 should be sufficient to decrease the tertiary radiation to the desired level. Thus, the thickness will depends on several factors, such as the material used in the tertiary shielding, the space available for the tertiary shielding, and secondary shielding material. For example, when aluminum is used as the tertiary shielding, the thickness of the aluminum can range from about a few millimeters to several millimeters. For other materials, the thickness will be determined by the mass absorption coefficient.

Like the primary and secondary shielding, the tertiary shielding is bombarded with radiation and, in turn, will emit radiation. Additional shielding mechanisms can be used, if necessary, to reduce or eliminate the radiation emitted from the tertiary shielding. The additionally shielding means can comprise a fourth (and fifth and sixth, etc . . . ) shielding. The number of additional shields will depends on the acceptable x-ray energy level that will not interfere with the detector's operation, the sample irradiated by the XRF device, the space available for the shielding, and mass absorption coefficient of the material used.

The following non-limiting example illustrates the present invention.

### EXAMPLE

An oil sample was obtained and then analyzed using an XRF apparatus. The detection apparatus contained several components. A trigger actuated tungsten shutter block containing an Cadmium 109 gamma ray point source and a silicon pin x-ray detector were located within the front of the instrument. A silver coating lined the tungsten shutter block. Circuit boards, necessary for acquiring and processing the data from the detector were located within the rest of the housing. The instrument had a red and a green light to indicate whether the sample was tagged or not and a read out to inform the user that the sample was tagged. A keypad on the top of the instrument allowed the user to turn the electronics of the instrument on and off, while a key operated lock on the side of the instrument kept the user from inadvertently opening the shutter block, exposing the radioactive source.

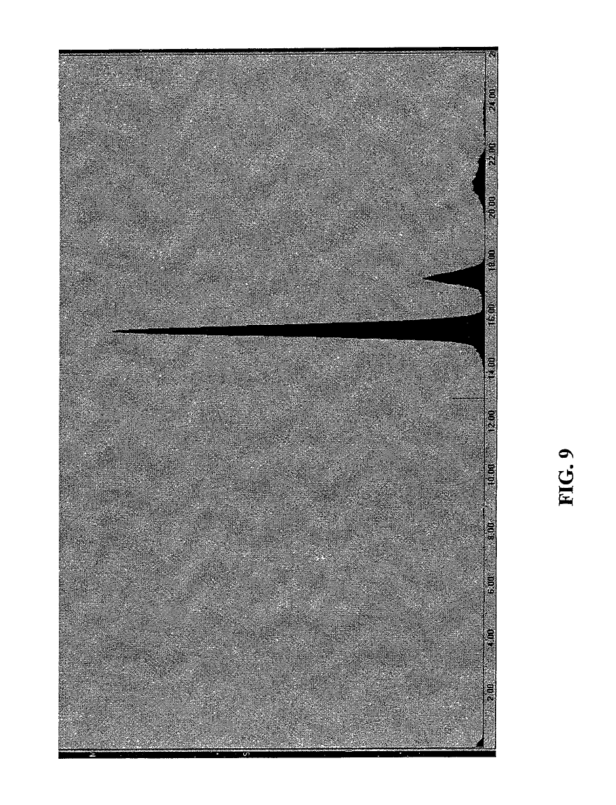

The spectra for the oil is depicted in FIG. 9. Without the silver lining on the tungsten housing, there would be a major peak appearing at 8.39 KeV (L alpha), another peak at 9.63 KeV (L beta), and another peak at 1.77 KeV.

Having described the preferred aspects of the invention, it is understood that the invention defined by the appended claims is not to be limited by particular details set forth in the above description, as many apparent variations thereof are possible without departing from the spirit or scope thereof.

We claim:

1. An electronic device, comprising:
an x-ray source comprising primary shielding means and secondary shielding means; and
an x-ray detector.

2. The device of claim 1, wherein the source and the detector are proximate each other.

3. The device of claim 2, wherein the source and detector are located within the same housing.

4. The device of claim 1, the primary shielding means shielding the detector from x-rays with a first energy.

5. The device of claim 4, the secondary shielding means shielding the detector from x-rays with a second energy lower than the first energy.

6. The device of claim 1, the primary shielding means comprising tungsten

7. The device of claim 1, the secondary shielding means comprising silver.

8. The device of claim 5, further including a tertiary shielding means.

9. The device of claim 8, the tertiary shielding means shielding the detector from x-rays with a third energy lower than the second energy.

10. An electronic device, comprising:
an x-ray source comprising a shield;
an x-ray detector; and
means for reducing radiation from the shield.

11. A device for providing an x-ray, comprising an x-ray source containing primary shielding means and secondary shielding means.

12. The device of claim 1, the primary shielding means shielding x-rays with a first energy.

13. The device of claim 12, the secondary shielding means shielding x-rays with a second energy lower than the first energy.

14. The device of claim 11, the primary shielding means comprising tungsten.

15. The device of claim 11, the secondary shielding means comprising silver.

16. The device of claim 13, further including a tertiary shielding means.

17. The device of claim 16, the tertiary shielding means shielding x-rays with a third energy lower than the second energy.

18. An electronic device, comprising:
an x-ray source comprising a shield;
an x-ray detector; and
means for filtering radiation of a desired energy level emanating from the shield.

19. An XRF device, comprising:
an x-ray source comprising primary shielding means and secondary shielding means; and
an x-ray detector.

20. The device of claim 19, wherein the source and detector are located within the same housing.

21. The device of claim 19, the primary shielding means shielding the detector from x-rays with a first energy and the secondary shielding means shielding the detector from x-rays with a second energy lower than the first energy.

22. The device of claim 19, the primary shielding means comprising tungsten and the secondary shielding means comprising silver.

23. The device of claim 21, further including a tertiary shielding means that shields the detector from x-rays with a third energy lower than the second energy.

24. An XRF device, comprising:
an x-ray source comprising primary shielding means and secondary shielding means; and
an x-ray detector; wherein the primary shielding means shields the detector from x-rays with a first energy and the secondary shielding means shields the detector from x-rays with a second energy lower than the first energy.

25. An XRF device, comprising:
an x-ray source comprising primary shielding means, secondary shielding means, and tertiary shielding means; and
an x-ray detector;
wherein the primary shielding means shields the detector from x-rays with a first energy, the secondary shielding means shields the detector from x-rays with a second energy lower than the first energy, and the tertiary shielding means shields the detector from x-rays with a third energy lower than the second energy.

26. A portable XRF device, comprising:
an x-ray source located in a housing, the source comprising primary shielding means and secondary shielding means; and
an x-ray detector located in the housing;
wherein the primary shielding means shields the detector from x-rays with a first energy and the secondary shielding means shields the detector from x-rays with a second energy lower than the first energy.

27. The device of claim 26, further including a tertiary shielding means that shields the detector from x-rays with a third energy lower than the second energy.

28. A system for detecting a taggant, comprising:
an x-ray source comprising primary shielding means and secondary shielding means; and
an x-ray detector;
wherein the primary shielding means shields the detector from x-rays with a first energy and the secondary shielding means shields the detector from x-rays with a second energy lower than the first energy.

29. A method for providing an x-ray, comprising
providing an x-ray source;
providing primary shielding means for the x-ray source;
providing secondary shielding means for the x-ray source; and
activating the x-ray source to provide an x-ray.

30. The method of claim 29, wherein the primary shielding means shields x-rays with a first energy and the secondary shielding means shields x-rays with a second energy lower than the first energy.

31. The method of claim 30, further comprising providing tertiary shielding means for the x-ray source.

32. The method of claim 31, wherein the tertiary shielding means shields x-rays with a third energy lower than the second energy.

33. A method for detecting a taggant, comprising:
providing a taggant;
causing the taggant to radiate at least one x-ray by irradiating the taggant with an x-ray from an x-ray source containing primary shielding means and secondary shielding means for the x-ray source; and
detecting whether the at least one x-ray has a specific energy using an x-ray detector.

34. The method of claim 33, wherein the x-ray source and the x-ray detector are located within the same housing.
